(19) United States
(12) Patent Application Publication
(10) Pub. No.: US 2010/0201610 A1
(43) Pub. Date: Aug. 12, 2010

(54) LIGHT EMITTING DIODE LIGHT ARRAYS ON MESH PLATFORMS

(76) Inventors: PAUL LO, Kowloon (CN); Teddy Yeung Man Lo, Kowloon (CN); Eddie Ping Kuen Li, Ma On Shan (CN)

Correspondence Address: DICKSTEIN SHAPIRO LLP, 1633 Broadway, NEW YORK, NY, 10019, US

(21) Appl. No.: 12/702,979

(22) Filed: Feb. 9, 2010

Related U.S. Application Data
(60) Provisional application No. 61/151,143, filed on Feb. 9, 2009.

(51) Int. Cl. G09G 3/32

(52) U.S. Cl. 345/82

(57) ABSTRACT

Light emitting diodes (LED) panels are provided that are made using a flexible or solid platform in a mesh form, the mesh being constructed from a first plurality of conductive strips, arranged in a first direction, and a second plurality of conductive strips, arranged in a second direction such that the first and second plurality of conductive strips form plural intersection therebetween, and a plurality of LED modules, each of the plurality of LED modules being arranged at one of the plural intersections, each LED module configured to receive display signals from at least one of the braided wire conducting strips and display light in accordance with the received signals. Also, multi-layer LED panels are provided with LEDs bonded on a base layer which conducts thermal energy. Further, LED devices are provided comprising a plurality of dynamically addressing LED modules.

### CROSS-REFERENCE TO RELATED APPLICATION

This utility application claims benefit under 35 U.S.C. §119(e) of U.S. Provisional Application No. 61/151,143, filed Feb. 9, 2009, which is hereby incorporated by reference.

### BACKGROUND OF THE INVENTION

One major problem with conventional light emitting diode (“LED”) light arrays relates to heat, based on the fact that increasing the temperature of a junction increases the current flow and this, in turn, causes increased heating and even higher temperatures, until finally the LEDs will fail. This problem may be partially alleviated, but hot solved, by the use of current limiting resistors and by providing heat sinks with sufficient ventilation to cool the heat sinks. However, the aforementioned problem relating to heat becomes more acute in mass LED displays where individual LEDs are mounted in close proximity to one another and where space may be limited to the point where current limiting resistors cannot be mounted. Mass LED light arrays are needed in applications where an efficient form of illumination is required to replace conventional fluorescent tubes and where illuminated vertical and horizontal LED panels are required. Additionally, mass LED light arrays are needed in creating scalable display screens (such as television screens).

### BRIEF SUMMARY OF THE INVENTION

In consideration of the above problems, in accordance with a first aspect, LED panels are provided that are made using a flexible of solid platform in a mesh form, the mesh being constructed from a plurality of conductive strips which themselves act as both electrical and heat conductors. The open mesh construction allows air to circulate freely around the conductor strips of the mesh and around the LED packages mounted on the mesh; thereby, maintaining the whole assembly at a low operating temperature.

In accordance with another aspect of the invention, a multi-layer LED panel structure is provided, with LEDs, e.g., comprising 3 LED chips in 1 package, bonded on a bottom layer. According to this aspect, the bottom layer conducts thermal energy and acts as an electrical ground, while the other layers act as independent buses for individual control of color display, and provide electrical conduction and LED addressing.

In yet another aspect, the present invention is directed to a flexible mesh display device, comprising a first plurality of braided wire conductive strips, arranged in a first direction; a second plurality of braided wire conductive strips, arranged in a second direction such that the first plurality of conductive strips and the second plurality of conductive strips form plural intersections therebetween; and a plurality of light emitting diode (LED) modules, each module forming a pixel of the display device, each of the plurality of LED modules being arranged at one of the plural intersections, each LED module configured to receive display signals from at least one of the braided wire conducting strips and display light in accordance with the received signals.

In another aspect, each of the braided wire conductive strips of each of the first and second plurality of conductive strips has a flattened cross-sectional profile.

In another aspect, the first and second plurality of braided wire conductive strips contact one another at the intersections.

In another aspect, each LED module has a microcontroller and one or more ports, the microcontroller being configured to check a status of at least one of the one or more ports; and, if the status of the port corresponds to a predetermined state, assign the LED module to which the microcontroller belongs to a first display address, and send signals to the microcontrollers of other ones of the LED modules in the display device, the signals assigning respective further display addresses to the other ones of the LED modules in the display device.

In another aspect, the display device further comprises a display memory storing current display information associated with the addresses of the pixels of the display, the information stored in the display memory being accessible by each of the microcontrollers of the LED modules, such that the microcontrollers can retrieve current information for display.

In another aspect, the display device further comprises a display controller, the display controller being configured to update the display information stored in the display memory.

In another aspect, each LED module includes one or more LEDs.

In another aspect, the LEDs in each LED module include red, blue and green LEDs. The one or more LEDs can also be a red, a blue, a green or a white LED.

In another aspect, each LED module is electrically connected to at least one of the conductive strips.

In another aspect, each LED module is electrically connected to at least one of the conductive strips by contacting the at least one conductive strip.

In another aspect, each LED module is electrically connected to at least one of the conductive strips by a lead line from the LED module to the at least one conductive strip.

In yet another aspect, the present invention is directed to a multi-layer display device, comprising a first layer comprising a base layer that conducts at least thermal energy; a second layer, arranged to contact, directly or indirectly, the first layer, the second layer comprising one or more second layer independent buses, arranged in a first direction, for controlling at least one of R, G, and B color control and electrical ground; a third layer, comprising one or more third layer independent buses arranged in a second direction different from the first direction, the third layer independent buses controlling the at least one of R, G, and B color control and electrical ground that are hot controlled by the second layer independent buses; and a plurality of light emitting diode (LED) modules, each module forming a pixel of the display device, each of the plurality of LED modules being mounted on the first layer, each LED module configured to receive display signals from at least one of the second layer independent buses and the third layer independent buses and display light in accordance with the received signals.

In another aspect, the second layer comprises the independent buses for R, G, and B color control, and the third layer comprises the independent buses for electrical ground.

In another aspect, the second layer comprises the independent buses for two of R, G, and B color control, and the third layer comprises the independent buses for electrical ground and the independent buses for color control hot located in the second layer.

In another aspect, each LED module has a microcontroller and one or more ports, the microcontroller being configured to check a status of at least one of the one or more ports; if the status of the port corresponds to a predetermined state, assign the LED module to which the microcontroller belongs to a first display address, and send signals to the microcontrollers of other ones of the LED modules in the display device, the signals assigning respective further display addresses to the other LED modules in the display device.

In another aspect, the display device further comprises a display memory storing current display information associated with the addresses of the pixels of the display, the information stored in the display memory being accessible by each of the microcontrollers of the LED modules, such that the microcontrollers can retrieve current information for display.

In another aspect, the display device further comprises a display controller, the display controller being configured to update the display information stored in the display memory.

In another aspect, each LED module includes one or more LEDs.

In another aspect, the LEDs in each LED module include red, blue and green LEDs. The one or more LEDs can also be a red, a blue, a green or a white LED.

In another aspect, the first, second and third layers are flexible.

In yet another aspect, the present invention is directed to a light emitting diode (LED) device, comprising (a) a plurality of LED modules, each LED module including: one or more LEDs; a microcontroller; and one or more ports, the microcontroller being configured to check a status of at least one of the one or more ports; if the status of the port corresponds to a predetermined state, assign the LED module to which the microcontroller belongs to a first display address, and send signals to the microcontrollers of other ones of the LED modules in the display device, the signals assigning respective further display addresses to the other LED modules in the LED device; and (b) a display memory, coupled to the plurality of LED modules, the display memory storing a current display status for each of the LED modules in the LED device.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIG. 1 is a view showing the structure of a conductive strip utilizable in an embodiment of the present invention;

FIG. 2 is a view of a rigid mesh type LED panel according to a first embodiment of the present invention;

FIG. 3 is an exploded view showing how the rigid mesh type LED panel of FIG. 1 is constructed;

FIG. 4 is a view of a rigid mesh type LED panel according to a second embodiment of the present invention;

FIG. 5 is a top view of a flexible mesh type LED panel according to a third embodiment of the present invention;

FIG. 6 is a close up view of the flexible mesh type LED panel according to the third embodiment;

FIG. 7 is a view of the underside of the flexible mesh type LED panel according to the third embodiment;

FIG. 7A is a view of a flexible mesh type LED panel wrapped around a spherical surface;

FIG. 8 is a plan view of a multi-layered mesh type LED panel according to a fourth embodiment of the present invention;

FIG. 9 is a view of a three-layered mesh type LED panel according to a fifth embodiment of the present invention;

FIG. 10 is a view of a three-layered mesh type LED panel according to a sixth embodiment of the present invention;

FIG. 11 is a diagram showing ah LED module suitable for use in dynamic addressing in the LED panels described in the present application; and

FIG. 12 is a diagram showing plural LED modules as shown in FIG. 11 in a matrix array.

### DETAILED DESCRIPTION OF THE INVENTION

According to a first embodiment, a mesh type LED panel is formed using conductive strips that have an insulating substrate bonded to one side of the conductor strip so that a longitudinal strip is isolated from a transverse strip above it While the term display is used generally, it is known in the art that an LED display acts also as an illumination device. Thus, when the term “display” is used, that term is intended in this application to cover the use of LEDs in displays and in illumination devices. FIG. 1 shows one type of construction of the conductive strip, for use in the LED panel, having an insulating substrate.

As shown in FIG. 1, in accordance with a preferred embodiment, the conductive strip 8 comprises a conductor 10, and bonding films 12 and 16 sandwiching an insulator 14. The conductive strips may be of any conductive material, such as copper or brass, plated or bare, of aluminum, or the like. Similarly, the insulator 14 may be formed from any appropriate insulating material known to those skilled in the art or developed hereafter.

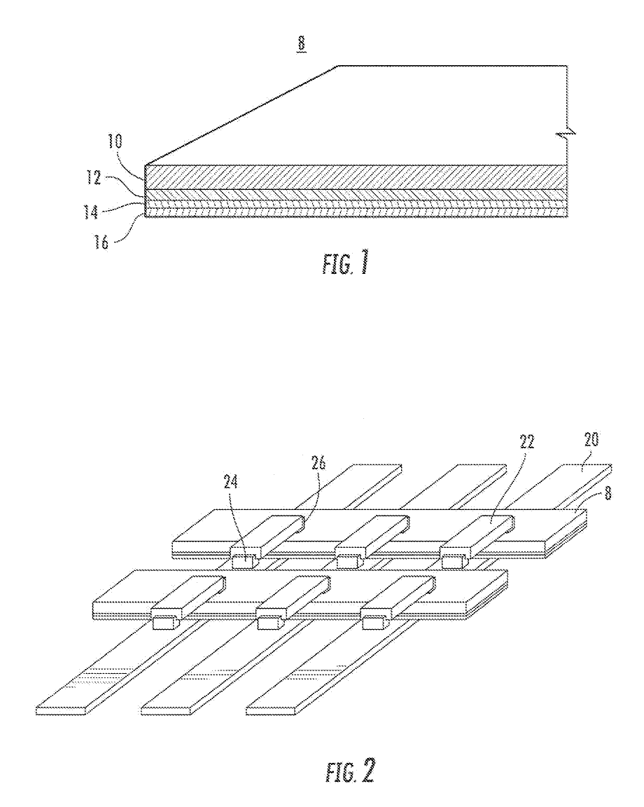

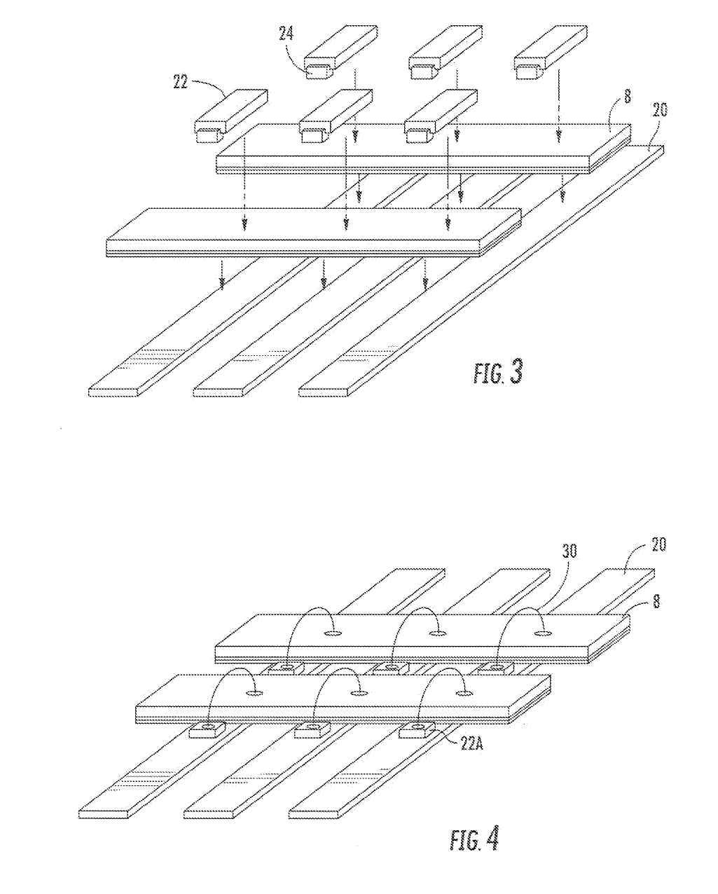

FIG. 2 shows an exemplary embodiment of an LED panel comprising a light array display device utilizing a rigid mesh, the mesh being constructed as a grid or matrix with longitudinal and transverse conductive strips in separate layers, the two sets of strips being bonded at their junctions. In the illustrated embodiment, transverse conductive strips 8, having an insulating structure formed in the manner shown in FIG. 1, are connected at intersections with longitudinal conductive strips 20. Because of the insulation, the conductive strips 8 can contact the longitudinal conductive strips 20 without causing interference with signals being carried oh conductive strips 20. It is noted that conductive strips 20 may be made of any conductive material, such as copper or brass, plated or bare, of aluminum, or the like.

An LED package 22 is connected, at each intersection of conductive strips 8 and 20. At each intersection, the LED package 22 is electrically connected to longitudinal conductive strip 20 by solder 24, and to transverse conductive strip 8 by solder 26. As will be appreciated, the invention is not limited to this manner of electrical connection and the connection may be made by any other manner of electrical connection known to those skilled in the art, including, but not limited to welding.

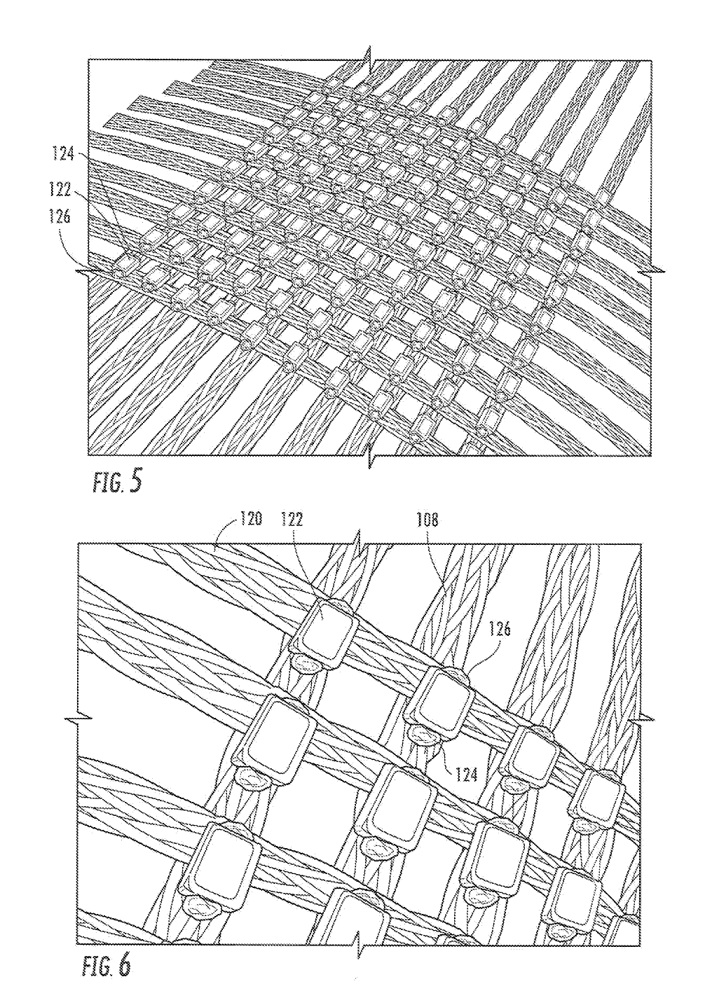

In the embodiment shown in FIG. 2, each LED package 22 is mounted on the transverse conductor strip 8 by chip bonding. Placement of the LED chips may be done, e.g., manually or by a pick-and-place machine. FIG. 3 is an exploded view of the embodiment of FIG. 2 showing the components before they are connected together to form the light array.

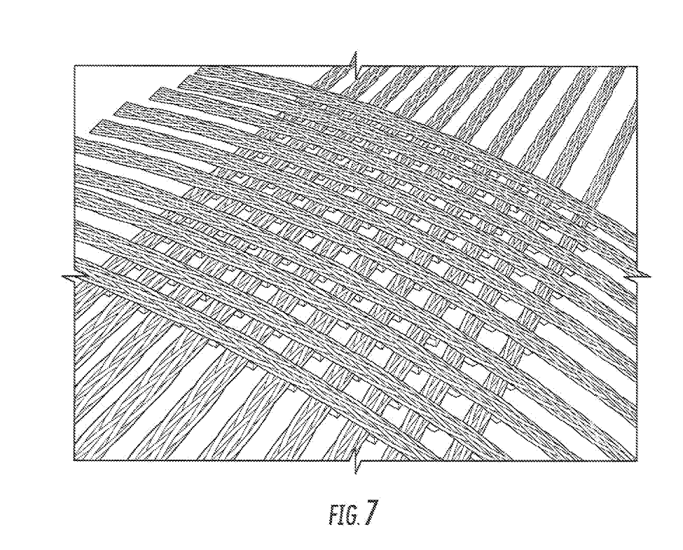

FIG. 4 shows a second embodiment of an LED light array display device using a rigid mesh. In this embodiment, the conductive strips 8 and 20 are provided in a matrix, as in the first embodiment, but the LEDs 22A are attached to the matrix using die and wire bonding, employing leads 30. Preferably the LEDs 22A used in this embodiment are of the Chip-On-Board (COB) type. As can be seen, in the second embodiment, the electrical connection between each LED 22A and a corresponding transverse conductive strip 8 is made using a lead 30. The terminal connection between the LED package 22A and the conductive strip on which it is mounted, in the illustrated embodiment the longitudinal conductive strip 20, may be made by soldering, welding or any other suitable method known in the art or developed hereinafter for creating an electrical connection. As in the first embodiment, placement of the chips may be done manually or by a pick-and-place machine.

In the embodiments shown in FIGS. 1-4, the rigid mesh is constructed as a grid or matrix with longitudinal and transverse conductive strips in separate layers, the two layers being bonded at their junctions.

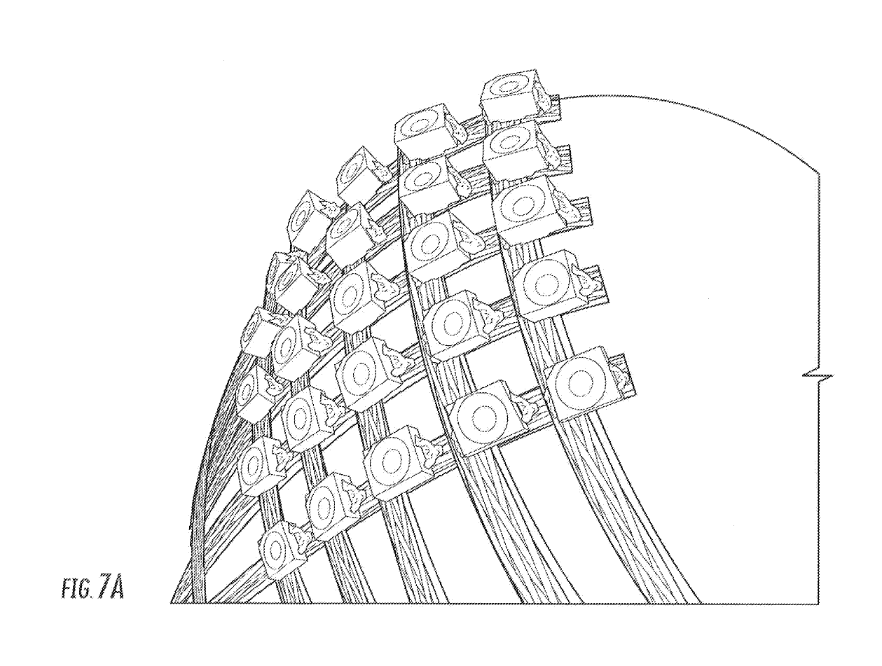

The LED light array display device discussed above can also be formed using a flexible mesh, instead of the rigid mesh embodiment shown in FIGS. 1-4. In a third embodiment, shown in FIGS. 5-7, the same general connection techniques for the LEDs 122 as in the rigid embodiments can be employed. For example, FIGS. 5 and 6 show an LED panel comprising a light array device in which the conductive strips 108 and 120 are formed of stranded or braided wire, which comprises a plurality of electrical conductive fine wires made of copper, brass, aluminum, or the like. Such fine wires may be bare or coated with an electrical conductive material including, but hot limited to, tin, nickel, silver, or the like. In the illustrated example of the flexible mesh embodiment, the conductive strips are constructed by braided fine wires flattened into a rectangular cross-section. An advantage to the use of the strips with a braid construction is that they are much more flexible than solid strips. A further advantage is that for any given cross-section, there is a bigger surface area to dissipate heat. For this reason a braided bus will run at a lower temperature than a solid bus. Moreover, the use of a flattened braided bus allows for ease of mounting LEDs on the bus, as the LEDs would normally have flat bottoms. However, the invention is not limited to this embodiment and the wire may also be a round stranded or braided wire.

As can be seen from FIGS. 5 and 6, the conductive strips 108 and 120, together forming a platform made up of braided wire, are electrically connected to the LED packages 122 at intersections of the conductive strips. As in the first embodiment, at each intersection, the LED package 122 is electrically connected to longitudinal conductive strip 120 by solder 124, and to transverse conductive strip 108 by spider 126. As was the case with the rigid mesh embodiment, the invention is not limited to this manner of electrical connection and the connection may be made by any other manner of electrical connection known to those skilled in the art, including, but not limited to welding.

In the flexible mesh embodiment, each LED package 122 is mounted on the transverse conductor strip 108 by chip, bonding. Placement of the LED chips may be done, e.g., manually or by a pick-and-place machine. FIG. 7 is an underside view of the flexible mesh embodiment shown in FIGS. 5 and 6.

In the embodiment shown in FIGS. 5-7, the flexible mesh is constructed as a grid or matrix with longitudinal and transverse conductive strips in separate layers. In the flexible mesh embodiment, the layers may be bonded at their junctions, as in the rigid mesh embodiments, or the mesh may be constructed by weaving. In the case of the woven form, the substrate of each of the conductive strips acts to isolate the longitudinal and transverse strips from each other. Further, in the woven form, there is no need to bond the two conductive strips at their junctions, thereby providing a mesh with greater flexibility.

For example, as shown in FIG. 7A, a display using a flexible mesh as described above is shown taking the shape of a spherical object. As will be understood by those of ordinary skill in the art, the flexible mesh can take on other shapes as well, allowing a display to be wrapped around, e.g., architectural features.

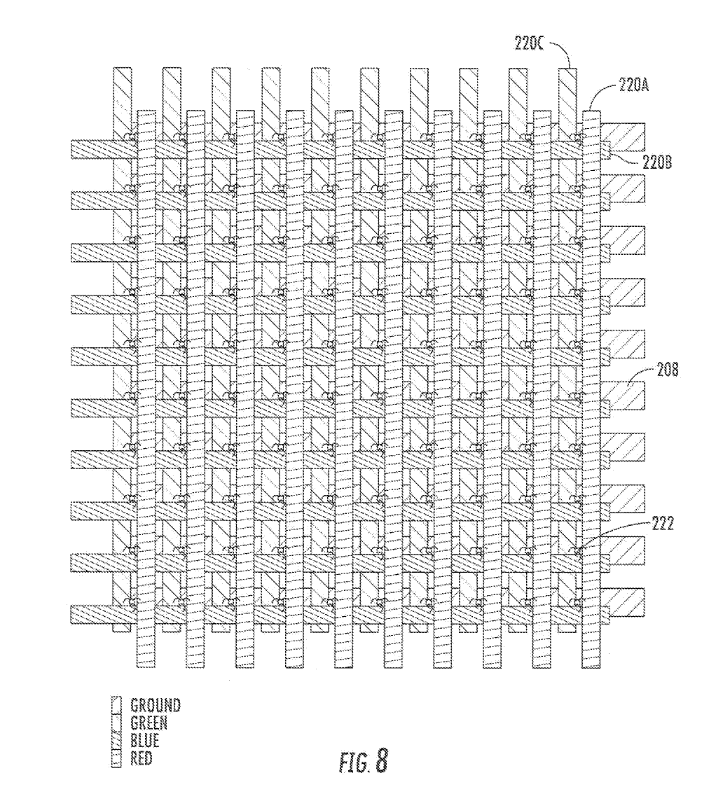

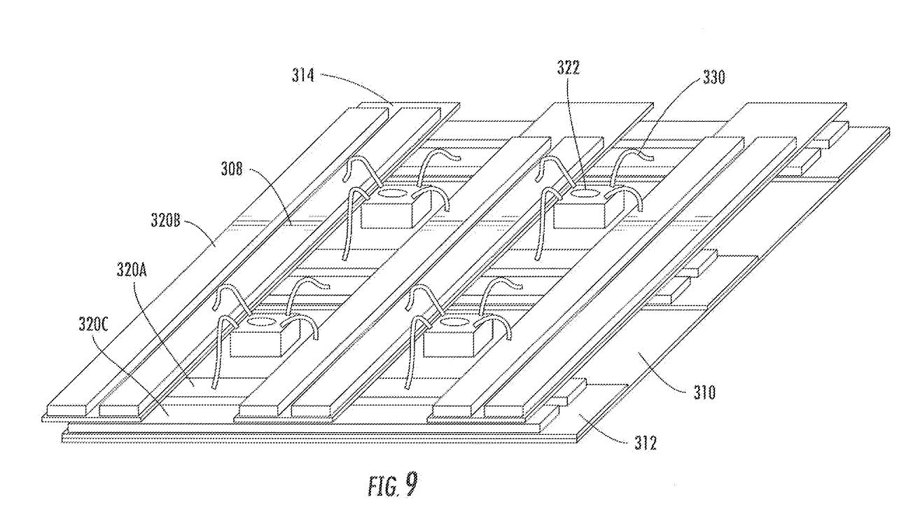

The embodiments illustrated in FIGS. 1-7A each form a single color LED light array. In an alternative embodiment, ah LED light array may have multiple layers of grids or matrix. For example, as shown in FIG. 8, a four-layer mesh is constructed, allowing for the driving of a three-color display.

As can be seen in FIG. 8, conductive strips 208, 220A, 220B and 220C, carrying drive signals for ground, red, blue and green display, respectively, are connected to a matrix of 3-color LED modules 222 at intersections of the conductive strips. Each LED package is connected to all four of the conductive strips to allow for a driving of the LED module to the appropriate color for the particular pixel it corresponds to. In the embodiment of FIG. 8, the LED module may be mounted, for example in a four-layer mesh, on the ground conductor with connections to ground strip by chip bonding, and to the three layers by die and wire bonding.

By providing such a four-layer mesh, which can employ any or all of the techniques described above in connection with the single color display embodiments, a color LED light array can be achieved. It is noted that the multi-layer embodiment may used a rigid or a flexible mesh, and may employ any known manner of electrical connection at the intersections, such as, but not limited to, those described above with respect to the embodiments of FIGS. 1-7A.

The 4-layer structure shown in FIG. 8, in a preferred embodiment, uses LEDs comprising of 3-LED chips in a single package, with each package bonded oh its bottom layer. This bottom layer serves to conduct thermal energy and to provide electrical ground. The other three layers comprise three independent buses for three color control individually, and are used for electrical conduction and LED addressing.

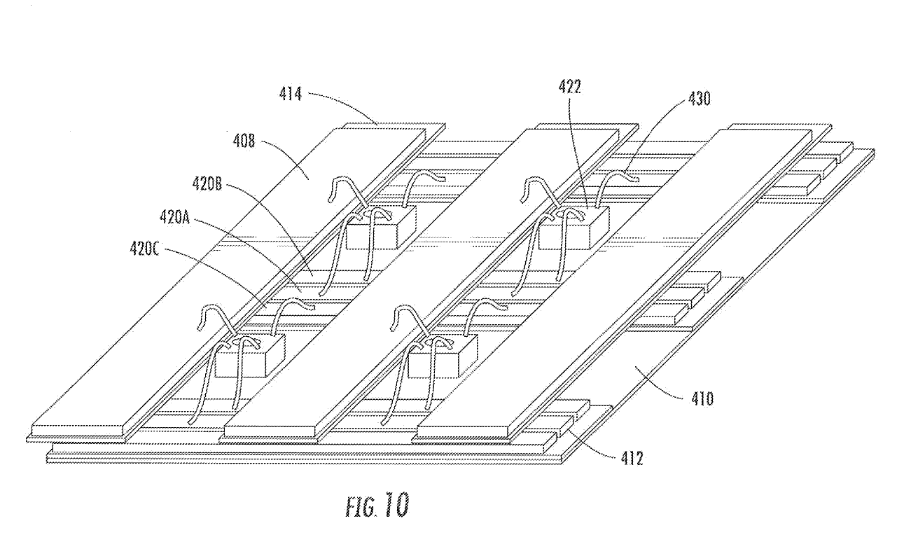

Another multi-layer embodiment is illustrated, with respect to FIG. 9. As shown in FIG. 9, a 3-layer structure is provided in which LEDs, each comprising 3-LED chips in one package 322, are bonded on a base layer 310. The base layer, preferably having a solid (or mesh, braided) sheet form, can be made of Cu, Al, Fe or their alloys, and serves to conduct thermal energy. The other 2 layers of the 3-layer structure each comprise 2 independent buses for respective ones of R, G and B color control and electrical ground, in particular, ground bus 308, red bus 320A, blue bus 320B, and green bus 320C.

As can be seen in FIG. 9, in this embodiment, the ground bus 308 and blue bus 320B are oriented parallel to one another in one direction, and the green bus 320C and the red bus 320A are oriented parallel to one another, and substantially perpendicular to the ground and blue buses. Each 3-LED chip is connect to all four buses so as to allow the LED chip to be driven for color display. An insulator 314 is provided under each set of blue and ground buses, while another insulator 312 is provided under each set of red and green buses. It should be noted that the buses need not be perpendicular, and may, for example, have another crossing configuration, such as, but not limited to, a parallelogram or a rhombus configuration.

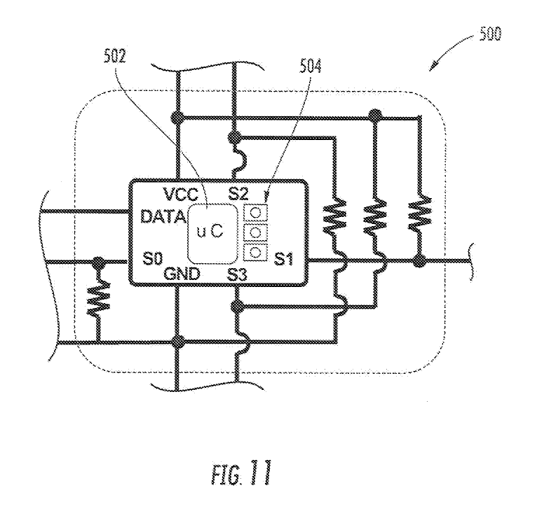

FIG. 10 shows another similar embodiment of the 3-layer structure, utilizing a base layer 410 that is the same as the base layer in FIG. 9. The 3-layer structure of FIG. 9 provides an individual layer for the electrical ground bus 408 and another layer with three independent buses, 420A, 420B and 420C, for control of the three colors. Having an individual layer reserved for ground provides for a better balance of electrical current between the ground bus and the buses for R, G and B colors. The embodiments in FIGS. 9 and 10 both provide for separate thermal and electrical conduction.

To achieve display drive, each pixel in the LED light arrays can be assigned an individual address, where each pixel is a LED module that includes a microcontroller and a plurality of LEDs (e.g., three (RGB), or four (RGBW) LEDs).

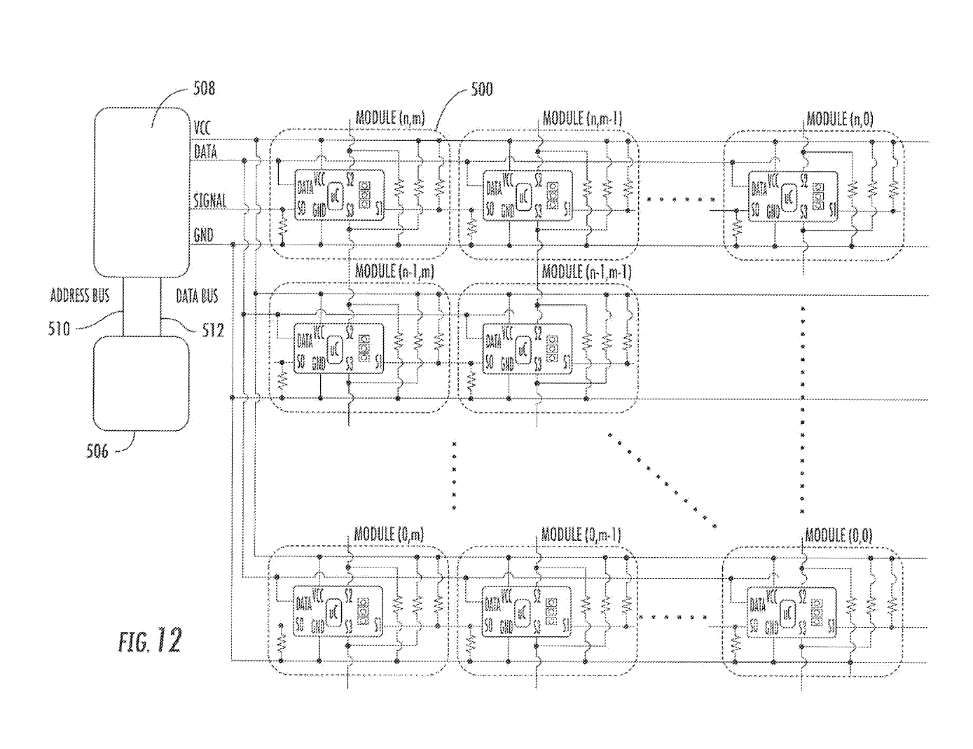

An example of such an LED module 500 suitable for use in a matrix display, such as those described in connection with the above embodiments, is shown in FIG. 11. An exemplary matrix having a number of such LED modules is illustrated in FIG. 12. Each LED module 500 comprising:
one or more LEDs (R, G, B or any other combination);
a microcontroller;
a data port (DATA);
four I/O ports, two of which are configured to be output ports (S0 and S2) and two of which are configured to be input ports (S1 and S3);
a power port (VCC); and
a ground port (GND).

As can be seen in FIGS. 11 and 12, a number of LED modules 500 are linked together to form a display. Preferably, the LED modules utilize a form of dynamic addressing, which will be described below in connection with these Figures. In dynamic addressing, the addresses of the pixels are assigned dynamically, by the pixels themselves, rather than preset during manufacture, as in static addressing.

Each LED module 500 preferably comprises a microcontroller 502 that (a) receives data from its own data port and receives commands and graphic signals, (b) performs the processing necessary for the pixel (LED module) on which it is located to participate the dynamic address system, and (c) drives the LED(s) in its own module, with together form a pixel.

The LED modules 500 are preferably connected as follows:
The VCC and GND ports are each connected between the power and ground buses.
The DATA ports are connected to a common bus.
The I/O ports S0 and S2 are out-ports and are grounded and the I/O ports S1 and S3 are imports and are connected to VCC. The in- and out-ports of neighboring LED modules are interconnected and where, on the periphery of the mesh no neighboring LED modules exist, they are left open. The wiring of the mesh is shown in schematic form in FIG. 12. It will be noted that the corner LED module at the bottom right hand corner of the mesh only has connections to its out-ports (S0 and S2) and, uniquely, has no connection to either of its two in-ports (S1 and S3). In the illustrated embodiment, it is the only LED module in the system which has two open in-ports, designating this particular LED module as the initiating LED module for dynamic addressing when the mesh is powered up. In the example illustrated in FIG. 12, this corner LED module is assigned position No. 0, 0.

That is, in this example, the microcontroller of the LED module in the bottom right hand corner, upon start up, or reset, for example, or at another time or periodically, cheeks the status of its ports and recognizes the status of the in-ports as having no connection (an open state in the illustrated embodiment). The LED module's microcontroller recognizes, from the status of these ports, that it has position 0, 0 and assigns itself that address. In contrast, the microcontrollers of the other LED modules would, upon checking their in-ports, recognize that they do have a connection, and would therefore not set their own address as 0, 0.

The microcontroller of LED module 0, 0 then starts the dynamic addressing by communicating its position to its neighboring LED modules as No. 0, 0 pixel and assigning thereby its neighbors' addresses as Nos. 0, 1 and 1, 0. The pixels with addresses so assigned then communicate with their succeeding neighbors, in a daisy chain recursion, assigning addresses as shown in FIG. 12. In this manner, the individual pixels, each controlled by a microcontroller, assign their own addresses when powered up and can re-assign their own addresses should one pixel fail. It should be noted that the status of the ports recognized by the microcontroller is not limited to being an open state, but may be any predetermined state that could be recognized by the microcontroller as being indicative of no connection.

In a preferred embodiment, all of the LED modules 500 share a single data line and each module sends to the remote display memory 506 requests for data (e.g., display-data), which data is changed and refreshed by a display controller 508.

The conventional manner, of handling display boards, by static addressing in which each pixel is pre-assigned a fixed address during manufacture, and is unable to monitor any changes, particularly as to shape or resolution in the display. Because dynamic addressing allows the pixels to reconfigure their addressing based on the signals received at an LED module, it can achieve flexibility as to installation, maintenance and failure detection.

The display controller 508 would, typically be programmed to update the display data in the display memory 506, and each pixel (LED module) picks up its respective data from the display memory 506. A function of the display controller 508 is to change and refresh the display memory. The display memory 506 and display controller 508 would preferably communicate with one another by the use of address bus, 510 and data bus 512, as is known to those skilled in the art.

Although the above description of dynamic addressing of a matrix display is the preferred method, other methods of driving a display using dynamic addressing are possible, such as, but not limited to having the display signals sent by the display controller, for example, received by each LED module, but only acted upon by the LED module haying the address of the display instruction from the controller.

A single-layer mesh LED light array, e.g., one of the arrays shown in FIGS. 2-7A, or a multi-layer mesh LED light array, e.g., one of the arrays shown in FIGS. 8-10, may be wired so that it contains a plurality of pixels (LED modules) electrically linked together to form a dynamic display. Conventional displays operate in a passive manner, with burst signals from a graphic controller to a display module. The display controllers in such conventional displays are required to know at least the exact number of pixels and the exact shape of the display module, and are unable to monitor any changes, particularly as to shape or resolution in the display. In contrast, each pixel (LED module) in a dynamic display module, as described above, has the intelligence to determine its own address and position in the dynamic display.

As discussed above, the pixel (LED module) can monitor in real-time the change in shape or in the number of pixels of a display unit, re-assigning its own address according to the changes. With this unique characteristic, a display mesh comprising such pixel (LED modules) can be split into multiple small display units or integrated into a large display unit, while maintaining its structural shape. The microcontroller of each pixel (LED module) can note the changes, e.g., to the state of its ports, independently and re-assign its own address and pick up the data from the corresponding display memory.

Similarly, the pixel (LED modules), using dynamic addressing, can be re-arranged into any desired shape and the displayed image can automatically re-scale to a suitable size without distorting the image. This is in contrast to conventional LED display modules in which the image would be distorted if the module were to be rearranged into another shape without reconfiguring the display controller. Such pixel (LED modules) may be used to create a scalable display screen, such as a scalable television screen. Such a scalable television screen may be split into multiple small television screens displaying different channels or programs.

Illumination

Panels comprising the LED light arrays described in connection with the above embodiments may be constructed in a shape of a square, rectangle, parallelogram, or rhombus, and the pitch of the LEDs may be varied to suit the requirements for the source light intensity. The LED light arrays in accordance with the present invention may be used in standard lighting fittings or lighting displays which required the use of rectilinear lighting modules. For example, the LED light arrays may be arranged as long narrow strips for applications met by fluorescent tubes, or in squares for flush fittings in false ceilings. Alternatively, the LED light arrays may form either part or all of an illuminated ceiling or wall. As shown above in reference to FIG. 7A, in the flexible mesh embodiment of the present invention, the LED light arrays may be used for specially constructed fittings for architectural effects, which may include columns, spheres, stars and other organic shapes.

The two-layer embodiments of the present invention may be used for a fixed single or multicolor use. The multi-layer embodiment of the present invention may have single colored LEDs, or multiple LEDs (e.g., three LEDs in red, blue and green) which may be used for full and variable color applications.

Display Screens

With the dynamic addressing system described above, the multi-layer mesh construction of the LED light arrays may be used in the construction of dynamic display screens including large television screens or “television walls.” Identical individual meshes may be mounted together, the unique address of each pixel (which comprises a microcontroller and a plurality of LEDs (e.g., three (RGB) or four (RGBW) LEDs)) being dynamically assigned.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that the present invention be limited only by the claims and the equivalents thereof.

What is claimed is:

1. A flexible mesh display device, comprising:
a first plurality of braided wire conductive strips, arranged in a first direction;
a second plurality of braided wire conductive strips, arranged in a second direction such that said first plurality of conductive strips and said second plurality of conductive strips form plural intersections therebetween; and
a plurality of light emitting diode (LED) modules, each module forming a pixel of the display device, each of the plurality of LED modules being arranged at one of the plural intersections, each LED module configured to receive display signals from at least one of the braided wire conducting strips and display light in accordance with the received signals.

2. The flexible mesh display device according to claim 1, wherein each of the braided wire conductive strips of each of the first and second plurality of conductive strips has a flattened cross-sectional profile.

3. The flexible mesh display device according to claim 1, wherein the first and second plurality of braided wire conductive strips contact one another at the intersections.

4. the flexible mesh display device according to claim 1, wherein each LED module has a microcontroller and one or more ports, said microcontroller being configured to:
check a status of at least one of the one or more ports; and
if the status of the port corresponds to a predetermined state:
assign the LED module to which said microcontroller belongs to a first display address, and
send signals to the microcontrollers of other ones of the LED modules in the display device, said signals assigning respective further display addresses to the other ones of the LED modules in the display device.

5. The flexible mesh display device according to claim 4, said display device further comprising:
a display memory storing current display information associated with the addresses of the pixels of the display, the information stored in said display memory being accessible by each of the microcontrollers of the LED modules, such that the microcontrollers can retrieve current information for display.

6. The flexible mesh display device according to claim 5, said display device further comprising:
a display controller, said display controller being configured to update the display information stored in said display memory.

7. The flexible mesh display device according to claim 1, wherein each said LED module includes one or more LEDs.

8. The flexible mesh display device according to claim 1, wherein the LEDs in each said LED module include red, blue and green LEDs.

9. The flexible mesh display device according to claim 1, wherein each LED module is electrically connected to at least one of the conductive strips.

10. The flexible mesh display device according to claim 9, wherein each LED module is electrically connected to at least one of the conductive strips by contacting the at least one conductive strip.

11. The flexible mesh display device according to claim 9, wherein each LED module is electrically connected to at least one of the conductive strips by a lead line from the LED module to the at least one conductive strip.

12. A multi-layer display device, comprising:
a first layer comprising a base layer that conducts at least thermal energy;
a second layer, arranged to contact, directly or indirectly, said first layer, said second layer comprising one or more second layer independent buses, arranged in a first direction, for controlling at least one of R, G, and B color control and electrical ground;
a third layer, comprising one or more third layer independent buses arranged in a second direction different from said first direction, said third layer independent buses controlling said at least one of R, G, and B color control and electrical ground that are not controlled by said second layer independent buses; and
a plurality of light emitting diode (LED) modules, each module forming a pixel of the display device, each of the plurality of LED modules being mounted on said first layer, each LED module configured to receive display signals from at least one of the second layer independent buses and the third layer independent buses and display light in accordance with the received signals.

13. The multi-layer display device according to claim 12, wherein the second layer comprises the independent buses for R, G, and B color control, and the third layer comprises the independent buses for electrical ground.

14. The multi-layer display device according to claim 12, wherein the second layer comprises the independent buses for two of R, G, and B color control, and the third layer comprises the independent buses for electrical ground and the independent buses for color control not located in the second layer.

15. The multi-layer display device according to claim 12, wherein each LED module has a microcontroller and one or more ports, said microcontroller being configured to:
check a status of at least one of the one or more ports;
if the status of the port corresponds to a predetermined state:
assign the LED module to which said microcontroller belongs to a first display address, and
send signals to the microcontrollers of other ones of the LED modules in the display device, said signals assigning respective further display addresses to the other LED modules in the display device.

16. The flexible mesh display device according to claim 15, said display device further comprising:
a display memory storing current display information associated with the addresses of the pixels of the display, the information stored in said display memory being accessible by each of the microcontrollers of the LED modules, such that the microcontrollers can retrieve current information for display.

17. The multi-layer display device according to claim 16, said display device further comprising:
a display controller, said display controller being configured to update the display information stored in said display memory.

18. the multi-layer display device according to claim 12, wherein each said LED module includes one or more LEDs.

19. The multi-layer display device according to claim 12, wherein the LEDs in each said LED module include red, blue and green LEDs.

20. The multi-layer display device according to claim 12, wherein the first, second and third layers are flexible.

21. The multi-layer display device according to claim 12, further comprising insulating material between the first layer and the independent buses of the second layer, and between the independent buses of the second layer and the independent buses of the third layer.

22. A light emitting diode (LED) device, comprising:
(a) a plurality of LED modules, each LED module including:
one or more LEDs;
a microcontroller; and
one or more ports, the microcontroller being configured to:
check a status of at least one of the one or more ports;
if the status of the port corresponds to a predetermined state:
assign the LED module to which said microcontroller belongs to a first display address, and
send signals to the microcontrollers of other ones of the LED modules in the display device, said signals assigning respective further display addresses to the other LED modules in the LED device; and
(b) a display memory, coupled to the plurality of LED modules, the display memory storing a current display status for each of the LED modules in the LED device.
